(19) United States
(12) Patent Application Publication
(10) Pub. No.: US 2026/0062261 A1
(43) Pub. Date: Mar. 5, 2026

(54) DEFLECTION DEVICE FOR DEFLECTING A ROPE WITH A ROPE SECURING MEMBER

(71) Applicant: Liebherr-Werk Ehingen GmbH, Ehingen/Donau (DE)

(72) Inventor: Bernd BOOS, Ehingen/Donau (DE)

(21) Appl. No.: 19/317,786

(22) Filed: Sep. 3, 2025

(30) Foreign Application Priority Data
Sep. 3, 2024 (DE) 10 2024 125 046.1

(51) Int. Cl. B66C 23/88; B66C 13/46; B66C 23/42; B66C 23/66; B66D 1/36

(52) U.S. Cl. CPC B66C 23/88; B66C 13/46; B66C 23/66; B66C 23/42; B66C 2700/0342; B66D 1/36

(57) ABSTRACT

The disclosure relates to a deflection device for deflecting a rope, comprising a roller holder, at least one deflection roller mounted on the roller holder so as to be rotatable about a roller axis of rotation, and a rope securing member spaced radially from the deflection roller for securing the rope to the deflection roller. According to the disclosure, the rope securing member is mounted so that it can be displaced along a displacement direction, wherein the deflection device comprises a detection device by means of which a displacement of the rope securing member along the displacement direction can be detected. The disclosure also relates to a working machine, in particular a crane, comprising a deflection device according to the disclosure, wherein the working machine comprises a boom with a boom head which comprises at least one deflection device over which a rope is guided.

### CROSS REFERENCE TO RELATED APPLICATION

The present application claims priority to German Patent Application No. 10 2024 125 046.1 filed on Sep. 3, 2024. The entire contents of the above-listed application are hereby incorporated by reference for all purposes.

### TECHNICAL FIELD

The present disclosure relates to a deflection device for deflecting a rope, as well as to a working machine comprising such a device.

### BACKGROUND

A large number of working machines have ropes which are deflected via at least one deflection roller on the machine, for example a hoisting rope which is reeved multiple times between deflection rollers of a boom head and a hook block. The deflection rollers are often secured by safety devices which ensure that the rope does not come out of the deflection rollers. An example of such safety devices are so-called rope protection bars, as are frequently used on mobile cranes or mobile cranes. These rope protection bars are arranged at a small distance outside the deflection rollers so that they do not touch the deflection rollers or the rope but prevent the rope from coming out of the groove in the deflection rollers.

### SUMMARY

When the rope is reeved, it often happens with such devices that the rope is not threaded between the rope protection bar and the deflection rollers, but is incorrectly guided over the rope protection bar on the outside. This can result in damage to the rope and other material damage.

The present disclosure is therefore based on the object of reliably preventing the risk of such incorrect reeving with conventional deflection devices.

According to the disclosure, this object is achieved by a deflection device and by a working machine having the features as described herein.

Accordingly, the disclosure proposes a deflection device for deflecting a rope, such as a hoisting rope of a crane, which comprises a roller holder, at least one deflection roller mounted on the roller holder so as to be rotatable about a roller axis of rotation, and a rope securing member. The latter is spaced radially from the deflection roller and serves to secure the rope to the deflection roller, i.e., to prevent the rope from slipping out of the deflection roller. When the term “deflection roller” is used in the singular in the following, it always refers to the at least one deflection roller.

According to the disclosure, the rope securing member is not fixed, i.e. is not immovable (apart from possible rotation about its longitudinal axis), as in known devices, but is mounted so that it can be displaced along a displacement direction. This mobility of the rope securing member can be provided, for example, by corresponding guide members of the roller holder or, alternatively, by guide members separate from the roller holder. If the rope is incorrectly guided outside the rope securing member and not between the rope securing member and the deflection roller, the rope presses against the rope securing member from the outside and displaces it along the displacement direction. The displacement of the rope securing member is optionally linear, although non-linear displacement paths may also be provided.

In order to detect incorrect rope reeving and to alert the personnel responsible for reeving, the deflection device also includes a detection device by means of which a displacement of the rope securing member along the displacement direction can be detected. If the rope securing member is displaced along the displacement direction by an incorrectly reeved rope, this is detected by the detection device and, if necessary, a corresponding warning is issued.

In principle, the detection device could be configured to detect even a slight or any displacement of the rope securing member from a normal position. However, it is also conceivable and useful for the rope securing member to be able to move a short distance from its normal position before detection by the detection device occurs. In the latter case, the detection device detects a displacement of the rope securing member from a certain distance.

The movable mounting of the rope securing member and the monitoring function of the detection device enable incorrect reeving of the rope to be detected easily and reliably.

In one possible embodiment, the displacement direction is perpendicular to the roller axis of rotation. In principle, displacement could occur along a non-linear trajectory, although simple linear displacement of the rope securing member is preferred.

Optionally, the displacement path (i.e., the trajectory that the rope securing member travels when viewed along its longitudinal axis) has a radial component with respect to the deflection roller. In other words, the displacement of the rope securing member may not be tangential with respect to the deflection roller, but at least to some extent in the radial direction. In principle, the displacement path could extend radially to the deflection roller, wherein a displacement path extending at an acute angle to the connecting line between the normal position of the rope securing member and the roller axis of rotation may be advantageous, since a longer displacement path is then available for the rope securing member to reliably detect a displacement while the rope securing member only moves slightly in the radial direction, so that there is not too great a distance between the normal position and the displaced position, at which a fault condition is detected, which would lead to the rope securing member coming into contact with the deflection roller or to the rope coming out in the normal position.

In a further possible embodiment, the rope securing member is mounted on the roller holder so that it can be displaced. This results in a particularly compact design of the deflection device. Optionally, the detection device is also arranged on the roller holder. To enable the rope securing member to be displaced, the roller holder optionally comprises corresponding guide members such as recesses or guide rails.

The rope securing member is optionally detachably fastened in at least one retaining member of the roller holders, either at one end or at both ends. This allows the rope securing member to be removed completely or partially from the holder for the purpose of reeving the rope and then reattached. A single-sided articulated mounting of the rope securing member would also be conceivable here.

In a further possible embodiment, the rope securing member is configured to extend parallel to the roller axis of rotation. In a conventional arrangement and orientation, both the roller axis of rotation and the rope securing member can extend in a horizontal direction, which refers in particular to a state in which the working machine on which the deflection device is arranged stands on a flat, horizontal surface.

Optionally, the rope securing member has the greatest distance from the roller axis in a normal position, which represents a state of the rope securing member without displacement. If the rope securing member is displaced due to a rope being reeved incorrectly by exerting pressure along the displacement direction, the rope securing member optionally moves closer to the deflection roller.

In a further possible embodiment, the rope securing member is pressed into the normal position by a tensioning device, and the detection device is configured to detect a displacement of the rope securing member from the normal position. The tensioning device may comprise one or more spring members and ensures that the rope securing member only moves out of the normal position when a certain force is exerted on it from outside, in particular a force exerted by an incorrectly reeved rope. If, on the other hand, the rope is correctly reeved, the rope securing member is in the normal position due to the preload provided by the tensioning device. Optionally, the detection device detects when the rope securing member moves in the displacement direction beyond a defined distance from the normal position.

In a further possible embodiment, the rope securing member is mounted in an elongated recess so that it can be displaced at at least one end, optionally at both ends. Optionally, the at least one recess is located on the roller holder so that the rope securing member is mounted on the roller holder in a displaceable manner. Alternatively, the at least one recess could be provided on at least one guide member (e.g., another sheet metal or a carrier with a recess) arranged separately from the roller holder.

When the recess is referred to in the singular in the following, both recesses are always meant in the case where the rope securing member is mounted so that it can slide at both ends. Optionally, the elongated recess is configured as an elongated hole, for example as a linear elongated hole.

The recess optionally comprises a first mechanical stop which defines the normal position of the rope securing member. The first mechanical stop can be a radially outer end of the recess or of the elongated hole. Optionally, the rope securing member is pressed outwards against the first mechanical stop by the aforementioned tensioning device.

In a further possible embodiment, the recess comprises a second mechanical stop which limits displacement of the rope securing member along the displacement direction, for example towards the deflection roller. If the rope is reeved incorrectly, the rope securing member can therefore move at most to the second mechanical stop. This can represent a radially inner end of the recess or of the elongated hole. Optionally, the second mechanical stop is arranged at an end of the recess opposite the first mechanical stop.

Alternatively or additionally, the second mechanical stop may be located closer to the roller axis of rotation than the first mechanical stop. The second mechanical stop thus prevents the rope securing member from contacting the deflection roller or exerting too much force on the deflection roller if the rope is incorrectly reeved.

In a further possible embodiment, the recess is configured such that the rope securing member does not come into contact with the deflection roller in any position along its displacement path. This prevents damage to the deflection roller or the rope securing member.

Optionally, the recess has a shorter length in the displacement direction than the diameter of the rope guided over the deflection roller. This ensures that the rope securing member is close enough to the at least one deflection roller in the normal position that the rope cannot come out.

In a further possible embodiment, the detection device is configured to interact mechanically with the rope securing member in order to detect displacement of the rope securing member. The detection device detects the displacement either directly from the start or only when a certain distance from the normal position is exceeded. For this purpose, the detection device optionally comprises a movable driver which, when the rope securing member is displaced along the displacement direction, is contacted by the rope securing member and moved with it. The driver is optionally arranged on the roller holder.

If a displacement of the rope securing member is detected right from the start, the driver can be in mechanical contact with the rope securing member in any position. If, on the other hand, a displacement of the rope securing member is only detected after a certain distance has been traveled, the driver is only contacted by the rope securing member from this point onwards. The driver can be a plunger connected to a sensor, for example a displacement or position sensor. The sensor is optionally arranged on the roller holder.

In another possible embodiment, the detection device is configured to detect a displacement of the rope securing member when it exceeds a defined distance from a normal position, as described above. Optionally, the defined distance at which the displacement of the rope securing member is detected can be changed and, in particular, adjusted by means of an adjustment device. This may be, for example, a mechanical adjustment device which, for example, changes a rest position of a driver that can be contacted by the rope securing member. If other sensors are used to detect the displacement or distance of the rope securing member, the defined distance can be set in other ways, for example digitally.

In a further possible embodiment, the detection device comprises an optical sensor (e.g., a laser sensor) and/or a magnetic sensor for detecting a current distance to the rope securing member. In principle, any sensors can be used to detect a distance to the rope securing member. It may be provided that a fault condition is detected when the detected distance falls below a defined limit value.

Alternatively, the displacement of the rope securing member can be detected by means other than distance measurement. For example, if the rope securing member is displaced, a rotary member could be set in rotation and the displacement detected indirectly via a rotary encoder. It is also conceivable to use strain gauges or other force or torque sensors that detect a force or torque acting on the rope securing member via an incorrectly reeved rope.

In a further possible embodiment, the detection device comprises a control unit which is configured to detect a displacement of the rope securing member along the displacement direction and then to emit an analog and/or digital warning signal which draws attention to the detected fault condition.

For example, the deflection device may comprise an acoustic warning signal emitter which is connected to the control unit and emits an acoustic warning signal when the control unit detects a displacement of the rope securing member. For this purpose, the detection device can be configured to transmit a warning signal in the form of an analog signal to the warning signal emitter, which in the simplest case can be a simple horn. The warning signal emitter can be arranged on the roller holder.

The use of an acoustic warning signal emitter on the deflection device, for example in the area of a roller head of a crane jib, can be advantageous because electrical cables are already laid in this area in many working machines, for example cables of a 24V on-board power supply system.

Alternatively or additionally, it would be conceivable to transmit a warning signal from the detection device to a control system of the working machine. For example, a digital warning signal can be transmitted to a driver's cab via a bus system. In this case, an acoustic output of a warning signal and/or an optical display of a warning or error message can be provided on a display and/or a signal lamp.

Alternatively or additionally, a corresponding warning can be displayed on a mobile device.

Alternatively or in addition to issuing a warning, the detection device can be configured to intervene in a machine control system, for example a crane control system, in the event of a fault and, for example, stop the current machine movement.

In a further possible embodiment, it is provided that several deflection rollers are mounted on the roller holder so as to be rotatable about the roller axis of rotation. In this case, the deflection device does not comprise a single deflection roller, but rather a roller package composed of at least two deflection rollers that are secured together via the rope securing member. In this case, the rope securing member optionally extends across all deflection rollers.

In principle, several rope securing members can be arranged per deflection roller, all of which can be mounted so as to be displaceable, for example in a single or in several roller holders or in separate guide members.

In a further possible embodiment, the rope securing member is configured as a rod. The rope securing member can therefore be a conventional rope protection rod.

The present disclosure also relates to a working machine with a deflection device according to the disclosure. This may have the same features, properties, and advantages as the deflection device according to the disclosure, so that a repetitive description is omitted. The working machine may be a crane, for example a lattice boom crane or a mobile crane, or a stationary crane such as a luffing crane, whose boom can carry the deflection device according to the disclosure. The working machine may also be a civil engineering machine, such as a vibratory pile driver or a carrier with a diaphragm wall cutter or a diaphragm wall grab, which may comprise a mast with a mast head arranged at the upper end of the mast with a deflection device according to the disclosure. In general, any working machine with at least one deflection roller over which a rope is guided is suitable for the application of the present disclosure.

Optionally, the working machine according to the disclosure comprises a boom with a boom head, which comprises at least one deflection device over which a rope, in particular a hoisting rope, which carries a hook block, is guided.

Furthermore, working machines with a boom and a roller head comprising two roller assemblies spaced apart from each other are known, for example mobile cranes with a telescopic boom. In this case, one of the roller assemblies or both roller assemblies can be realized by a deflection device according to the disclosure.

In one possible embodiment, the detection device of the deflection device of the working machine according to the disclosure is configured to detect a mis-winding of the rope, in which the rope is not guided between the rope securing member and the at least one deflection roller, but radially outside the rope securing member around the at least one deflection roller. In this case, the hoisting rope presses on the rope securing member from the outside and displaces it along the displacement direction, in particular in the direction of the at least one deflection roller. This displacement is detected by the detection device and, optionally, a warning is issued in response thereto.

Alternatively or additionally, it may be provided that the rope securing member is mounted so as to be displaceable at at least one end in an elongated recess as described above, in particular so as to be displaceable on the roller holder, and that the recess has a length which is shorter than the diameter of the rope guided around the deflection device. This ensures that the rope securing member is located close enough to the at least one deflection roller in the normal position so that the rope cannot come out.

### BRIEF DESCRIPTION OF THE FIGURES

Further features, details, and advantages of the disclosure will become apparent from the embodiments described below with reference to the figures. The Figures show in:

FIG. 1: a side view of an embodiment of the working machine according to the disclosure;

FIG. 2A, FIG. 2B, and FIG. 2C: side views of an embodiment of the deflection device according to the disclosure in different states when the rope securing member is displaced; and

FIG. 3: a front view of the boom head of the working machine according to the disclosure in accordance with an embodiment.

### DETAILED DESCRIPTION

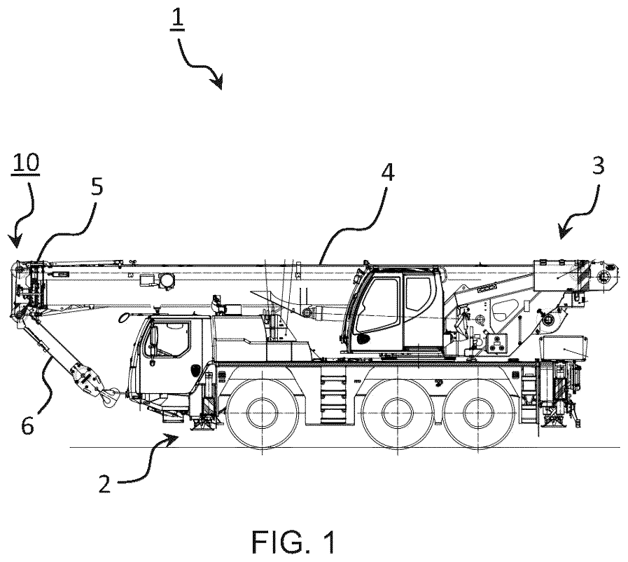

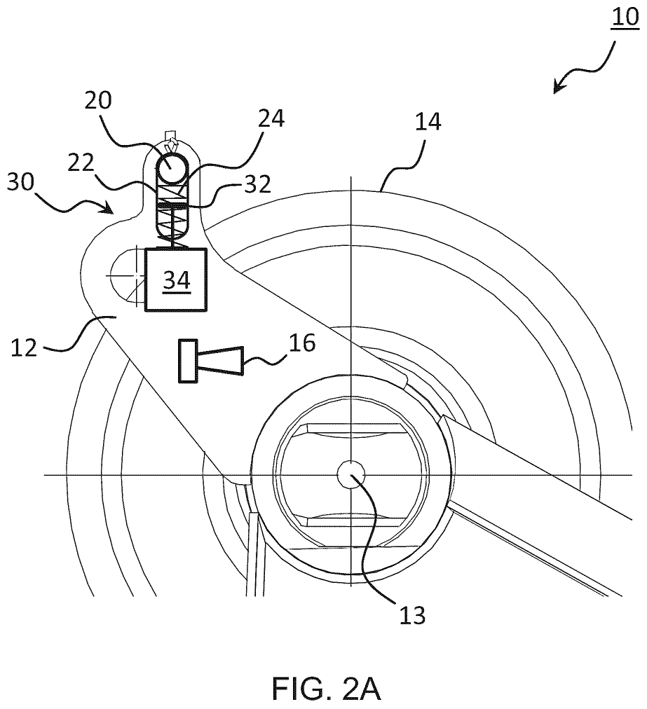

FIG. 1 shows a side view of an example of the working machine 1 according to the disclosure. The working machine 1 of the embodiment shown is a mobile crane with a mobile undercarriage 2, an upper carriage 3 mounted rotatably on the undercarriage 2, and a telescopic boom 4 arranged on the upper carriage 3, which has a boom head 5 at the end of the innermost telescopic section. A hoisting rope 6 is guided from a hoisting rope winch via several deflection rollers on the boom head 5 and is reeved between the deflection rollers and a hook block. The boom head 5 can have at least one deflection device 10 according to the disclosure for deflecting the hoisting rope 6. However, the present disclosure is not limited to this embodiment.

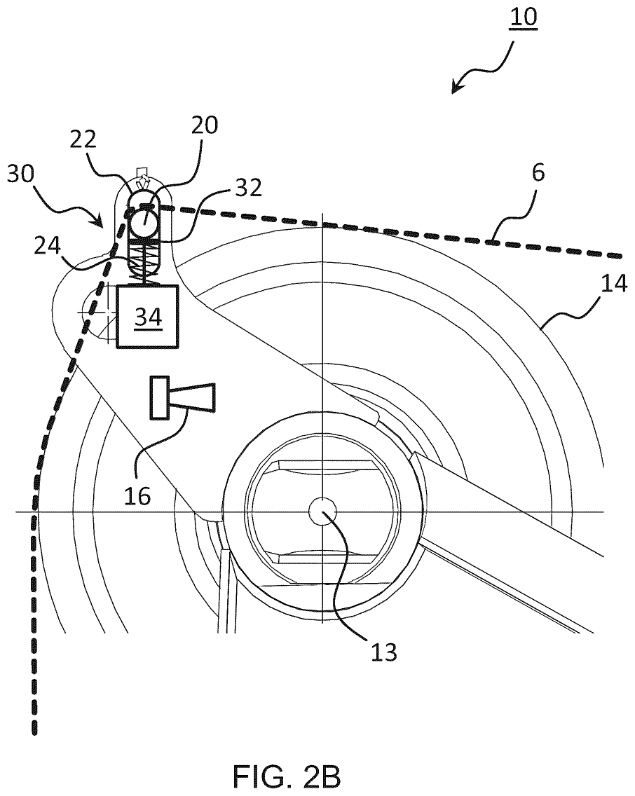

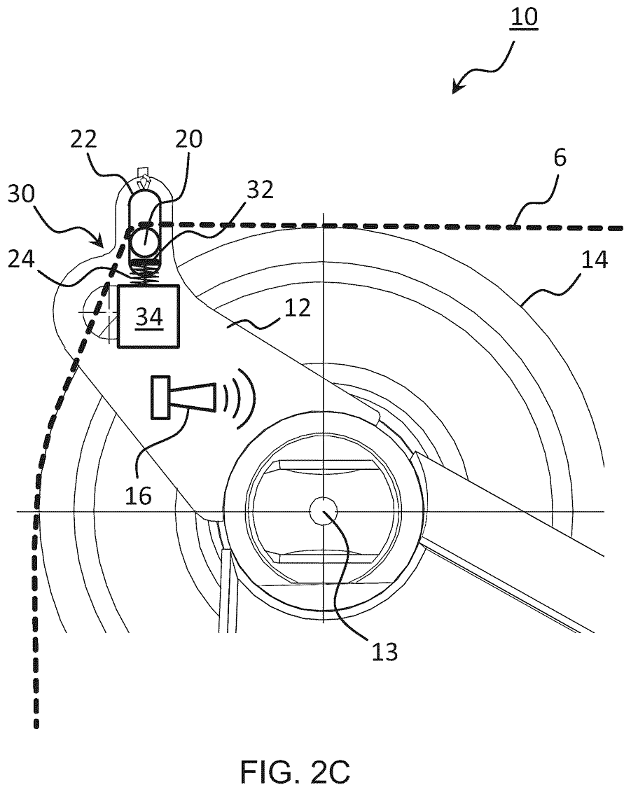

FIG. 2A-FIG. 2C show a side view of an embodiment of the deflection device 10 according to the disclosure. This comprises a roller holder 12 on which one or more deflection rollers 14 are mounted so as to be rotatable about a roller axis of rotation 13. The roller holder 12 can have two lateral holding arms or holding plates between which the at least one deflection roller 14 is arranged. For the sake of simplicity, the term “deflection roller 14” will be used in the following, although several deflection rollers 14 may also be present.

A rope securing member 20 is mounted on the roller holder 12, which may be configured as a rod with a round cross-section. The rope securing member 20 is mounted on the roller holder 12 so that it can be displaced. For this purpose, in the embodiment shown, elongated recesses 22 in the form of elongated holes are formed in the roller holder 12, in which the rope securing member 20 is mounted so that it can be displaced linearly. In principle, only one of the ends could be mounted in such a recess 22, whereby the rope securing member 20 is optionally mounted so that it can be displaced at both ends, so that it can move as a whole along the displacement direction defined by the recesses 22. Alternatively, one end or both ends of the rope securing member 20 could be mounted so as to be displaceable not directly in the roller holder 12 but in a guide member (for example, a sheet metal plate arranged next to the roller holder 12) separate from the roller holder 12.

The deflection device 10 comprises a detection device 30 which is capable of detecting a displacement of the rope securing member 20 along the recesses 22, in the embodiment shown, i.e. a displacement towards the deflection roller 14. Various detection solutions are conceivable for this purpose.

In the embodiment shown, the rope securing member 20 is biased via at least one spring member 24 (optionally at least two spring members 24) into the normal position shown in FIG. 2A, in which the rope securing member 20 is at the greatest distance from the deflection roller 14. The spring member 24 is a tensioning member. In an embodiment with elongated holes, the upper end of the elongated hole 22 or the end spaced apart from the deflection roller 14 acts as a first mechanical stop. In this position, the rope securing member 20 can be arranged as is known from previous static solutions. If the rope 6 is properly reeved between the deflection roller 14 and the rope securing member 20, the rope securing member 20 prevents the rope 6 from coming out of the deflection roller 14 via contact with the first mechanical stop.

If, on the other hand, the rope 6 is incorrectly guided outside the rope securing member 20, the weight of the rope 6 and any additional loads attached to it (e.g., a hook block) displace the rope securing member 20 in the displacement direction against the spring force of the spring members 24, in the embodiment shown, i.e., toward the deflection roller or deflection pulley 14.

The detection device 30 may comprise a driver 32 which may be arranged such that the rope securing member 20 contacts the driver 32 after being displaced by a defined distance and moves with it. The driver 32 can be connected to a corresponding sensor or transmitter 34, which detects such a movement of the driver 32 and transmits a signal to a control unit (not shown). This can be set up to emit an analog signal to a warning signal emitter 16, for example a horn attached to the roller holder 12, in response to this, thereby emitting an acoustic warning signal which draws attention to the detected incorrect reeving of the rope 6. This horn signal could immediately alert personnel located in the area of the deflection device who are performing the rope insertion to the incorrect insertion so that they can take steps to rectify the error. The acoustic warning signal could also be heard by a driver, for example a crane driver in a crane cabin, who could then take appropriate measures.

Alternatively or additionally, a digital signal could be transmitted to a driver's cab or to a machine control system, for example via an internal bus system, in order to issue an acoustic and/or visual warning, e.g. an error message on a display.

FIG. 2A shows the normal position of the rope securing member 20. FIG. 2B shows a situation in which a rope 6 has been incorrectly guided outside the rope securing member 20 and has already shifted a little inside the recess(es) 22. In the embodiment shown, the driver 32 is arranged at a certain distance from the normal position so that the rope securing member 20 only contacts the driver 32 after moving back the distance indicated in FIG. 2B. Alternatively, the driver 32 could contact the rope securing member 20 at a different distance or even already in the normal position in order to immediately detect any movement from the normal position. The position of the driver 32 and thus the sensitivity of the detection device 30 to displacements of the rope securing member 20 can be optionally adjustable.

In the situation shown in FIG. 2C, the rope 6 has moved the rope securing member 20 further toward the deflection roller 14, so that the driver 32 has also been moved, which has been detected by the sensor 34 and which emits a warning signal via the warning signal emitter 16.

The lower end of the recess 22 forms a second mechanical stop which defines the maximum distance by which the rope securing member 20 can be displaced. The recess 22 is configured in particular so that the rope securing member 20 does not contact the deflection roller 14 even when it rests against the second mechanical stop.

As shown in FIG. 2A-FIG. 2C, the recess 22 or recesses 22 can be formed directly in retaining plates of the roller holder 12. Other types of guidance for the rope securing member 20 are also conceivable.

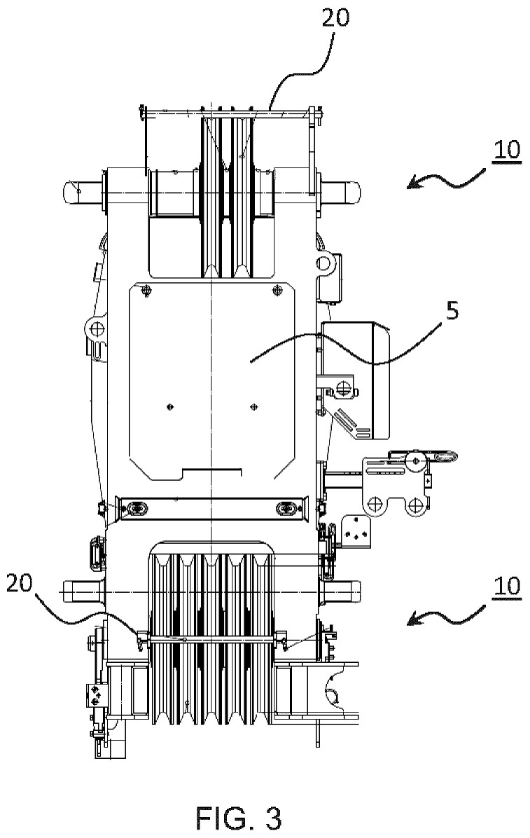

FIG. 3 shows an example of a boom head 5 which has an upper roller package and a lower roller package. Both roller packages can be formed by deflection devices 10 according to the disclosure in order to prevent the rope 6 from coming out for each roller package and to reliably detect incorrect reeving.

If there are several deflection rollers 14, as shown in FIG. 3, for example, the rope securing member 20 may extend in particular across all deflection rollers 14.

### LIST OF REFERENCE CHARACTERS

1 Working machine
2 Undercarriage
3 Upper carriage
4 Boom
5 Boom head
6 Rope
10 Deflection device
12 Roller holder
13 roller axis of rotation
14 deflection roller
16 warning signal emitter
20 rope securing member
22 recess
24 tensioning device
30 detection device
32 driver
34 sensor

1. A deflection device for deflecting a rope, comprising a roller holder, at least one deflection roller which is mounted on the roller holder so as to be rotatable about a roller axis of rotation, and a rope securing member spaced radially from the deflection roller for securing the rope to the deflection roller,
wherein the rope securing member is mounted on the roller holder so as to be displaceable along a displacement direction, wherein the deflection device comprises a detection device by means of which a displacement of the rope securing member along the displacement direction can be detected.

2. The deflection device according to claim 1, wherein the displacement direction is perpendicular to the roller axis of rotation and a displacement path of the rope securing member has a radial component with respect to the deflection roller.

3. The deflection device according to claim 1, wherein the rope securing member is mounted displaceably on the roller holder.

4. The deflection device according to claim 1, wherein the rope securing member extends parallel to the roller axis of rotation.

5. The deflection device according to claim 1, wherein the rope securing member is pressed into a normal position by a tensioning device by means of at least one spring member, and the detection device is configured to detect the displacement of the rope securing member out of the normal position by a defined distance.

6. The deflection device according to claim 1, wherein the rope securing member is mounted in an elongated recess at at least one end in a displaceable manner, wherein the rope securing member is displaceably mounted on the roller holder, and wherein the recess comprises a first mechanical stop which defines a normal position of the rope securing member.

7. The deflection device according to claim 6, wherein the recess comprises a second mechanical stop which limits displacement of the rope securing member along the displacement direction.

8. The deflection device according to claim 6, wherein the recess is configured such that the rope securing member does not come into contact with the deflection roller in any position along the displacement path.

9. The deflection device according to claim 1, wherein the detection device cooperates mechanically with the rope securing member to detect the displacement of the rope securing member.

10. The deflection device according to claim 1, wherein the detection device is configured to detect the displacement of the rope securing member when it exceeds a defined distance from a normal position, wherein the defined distance is adjustable by an adjustment device.

11. The deflection device according to claim 1, wherein the detection device comprises an optical sensor and/or a magnetic sensor for detecting a distance to the rope securing member.

12. The deflection device according to claim 1, wherein the detection device comprises a control unit which is configured to detect the displacement of the rope securing member along the displacement direction and then to emit an analog and/or digital warning signal, and wherein the deflection device comprises an acoustic warning signal emitter which is connected to the control unit and outputs an acoustic warning signal upon detection of the displacement of the rope securing member along the displacement direction by the control unit.

13. The deflection device according to claim 1, wherein a plurality of deflection rollers are mounted on the roller holder so as to be rotatable about the roller axis of rotation, and wherein the rope securing member extends across all deflection rollers.

14. A working machine, comprising the deflection device according to claim 1, wherein the working machine comprises a boom with a boom head which comprises at least one deflection device over which a hoisting rope which carries a hook block is guided.

15. The working machine according to claim 14, wherein the detection device is configured to recognize a mis-winding of the rope in which the rope is not guided between the rope securing member and the at least one deflection roller, but radially outside the rope securing member around the at least one deflection roller and/or wherein the rope securing member is mounted at least at one end in an elongated recess so as to be displaceable, and the recess has a length which is shorter than the diameter of the rope guided around the deflection device.

16. The deflection device according to claim 3, wherein the rope securing member is detachably secured in at least one retaining member of the roller holder.

17. The deflection device according to claim 4, wherein the rope securing member has the greatest distance from the roller axis of rotation in a normal position, which represents a state of the rope securing member without displacement.

18. The deflection device according to claim 6, wherein the at least one end is both ends.

19. The deflection device according to claim 7, wherein the second mechanical stop is arranged at an end of the recess opposite the first mechanical stop and/or closer to the roller axis of rotation than the first mechanical stop.

20. The deflection device according to claim 9, wherein the detection device comprises a movable driver which, upon displacement of the rope securing member along the displacement direction, is contacted and moved by the rope securing member.
